(19) United States
(12) Patent Application Publication
(10) Pub. No.: US 2018/0365379 A1
(43) Pub. Date: Dec. 20, 2018

(54) Adaptive Recording of Medical, Health and Fitness History

(71) Applicants: Martin Markley, Thousand Oaks, CA (US); Mirian Markley, Thousand Oaks, CA (US)

(72) Inventors: Martin Markley, Thousand Oaks, CA (US); Mirian Markley, Thousand Oaks, CA (US)

(21) Appl. No.: 15/627,182

(22) Filed: Jun. 19, 2017

(51) Int. Cl. G06F 19/00

(52) U.S. Cl. CPC G06F 19/322; H04L 63/08; G06F 19/363

(57) ABSTRACT

Disclosed herein are system, method, and computer program product embodiments for both discerning and recording indices of health and fitness for a person. An embodiment operates by presenting one or more first question to a user of an electronic device, receiving one or more first responses to the first questions, determining on that basis one or more additional questions relating to the health of the user, receiving one or more second responses to the additional questions, and generating, based on the first and second responses, a medical profile for the user.

### BACKGROUND

### Technical Field

Embodiments generally relate to computer-implemented systems, methods and products, for generating and maintaining electronic health records.

### Background

Within the allied healthcare fields, care providers agree that the more comprehensive a health profile one can create of an individual patient, client or subject, the more accurate and thus effective a regimen of treatment can be prescribed. To this end, providers usually employ various standardized and non-standardized medical questionnaires. Generally speaking, such questionnaires take the form of a written document with pre-formed fields, populated with questions and space wherein a client or patient can provide answers. Granted its ubiquity, there are apparent disadvantages with this type of questionnaire.

For example, such a questionnaire may be limited in terms of the depth of information it can provide, with respect to a patient or client's overall health profile. Whatever general rubric determines a set of valid questions for a given type of medical, health or fitness questionnaire, the health characteristics of individuals vary widely, which significantly limits the utility of any such general rubric. Furthermore, a simple pen-and-paper questionnaire lacks the immediate availability and portability of electronic information. Thus, a felt need exists for a type of medical, health and/or fitness questionnaire that comports itself better towards the unique health profiles of individuals, and which also takes a form that is more readily accessible.

### SUMMARY

Disclosed herein are system, method, and computer program product embodiments for both discerning and recording indices of health and fitness for a person. More specifically, embodiments may employ adaptive algorithms that create an intelligent questionnaire tailored to the unique set of a given individual's health characteristics, the answering of which is recorded as a comprehensive, electronically-based medical and fitness profile for the person in question. Embodiments also feature the further advantage of providing a profile in electronic form, which makes the information contained therein connected or connectible to a host of internet, intranet, and any other sort of conceivable electronic database systems.

In one aspect, embodiments describe a computer-implemented method comprising, by at least one processor, the presentation, for a user of an electronic device, of one or more questions relating to the health of the user.

In another aspect, the method comprises the receipt of one or more first responses to the first questions.

In another aspect, the method comprises the determination, based on the first responses, of one or more additional questions relating to the health of the user.

In yet another aspect, the method comprises the receipt of one or more second responses to the additional questions.

In still another aspect, the method comprises the generation, based on the first and second responses, of a medical profile for the user.

The embodiments disclosed above are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

The accompanying drawings are incorporated herein and form a part of the specification.

FIG. 1 illustrates a computer-network system environment, according to an example embodiment.

FIG. 2 illustrates the general environment in which embodiments may operate, according to an example embodiment.

FIG. 3 illustrates an electronic device and a user interacting, wherein the device presents the user with an auditory question, and the user speaks an answer through a microphone interface of the device, according to an example embodiment.

FIG. 4 illustrates a flowchart according to the method of the present invention.

FIG. 5 illustrates a decision-tree according to the method of the present invention.

FIG. 6 is an example computer system useful for implementing various embodiments.

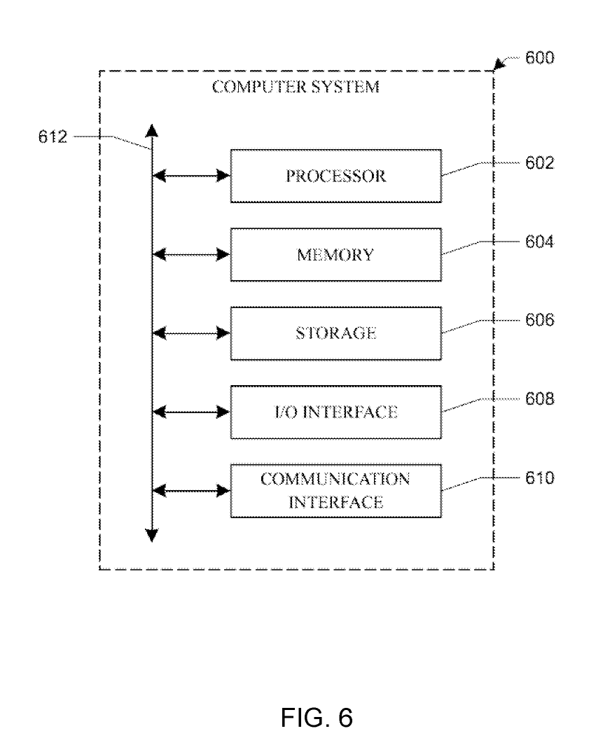

In the drawings, like reference numbers generally indicate identical or similar elements. Additionally, generally, the left-most digit(s) of a reference number identifies the drawing in which the reference number first appears.

### DETAILED DESCRIPTION

Provided herein are system, method and/or computer program product embodiments, and/or combinations and sub-combinations thereof, for creating an intelligent, adaptive questionnaire tailored to the unique set of a given individual's health characteristics, the answering of which is recorded as a comprehensive, electronically-based medical and fitness profile for the person in question.

While the embodiments described herein are exemplified in the context of a speech synthesis and voice recognition platform, they are generally applicable to any system that connects users through a computer interface.

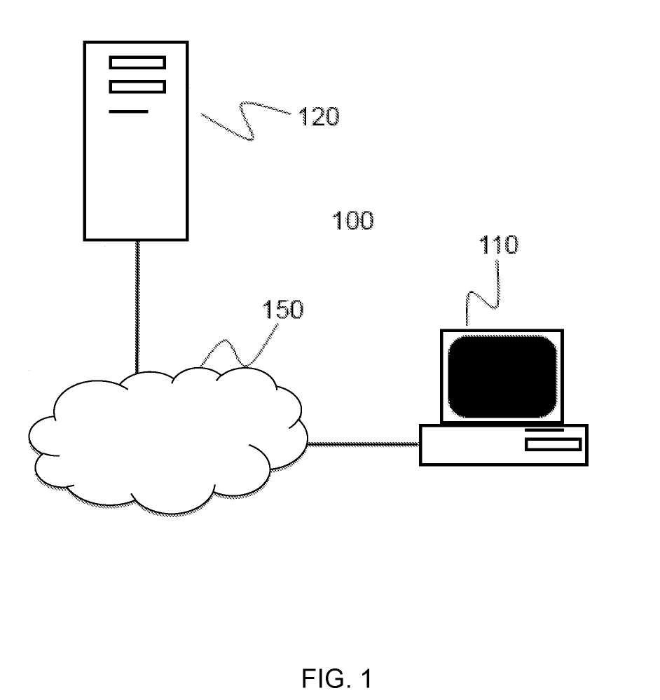

FIG. 1 illustrates a networking system environment 100, according to an example embodiment. A client system 110 connects to a server system 120 through a network 150. The network may be any communications network suitable for transmitting data between computing devices, such as, by way of example, a Local Area Network (LAN), a Wide Area Network (WAN), Metropolitan Area Network (MAN), Personal Area Network (PAN), the Internet, wireless networks, satellite networks, overlay networks, or any combination thereof. Client system 110 may be any computing device suitable for interacting with a social-networking system, such as, by way of example, a personal computer, mobile computer, laptop computer, mobile phone, smartphone, personal digital assistant, or tablet computer. Server system 120 may be any computing device or combination of devices suitable to provide health record generation services as described herein, such as, by way of example, server computers, database systems, storage area networks, web servers, application servers, or any combination thereof.

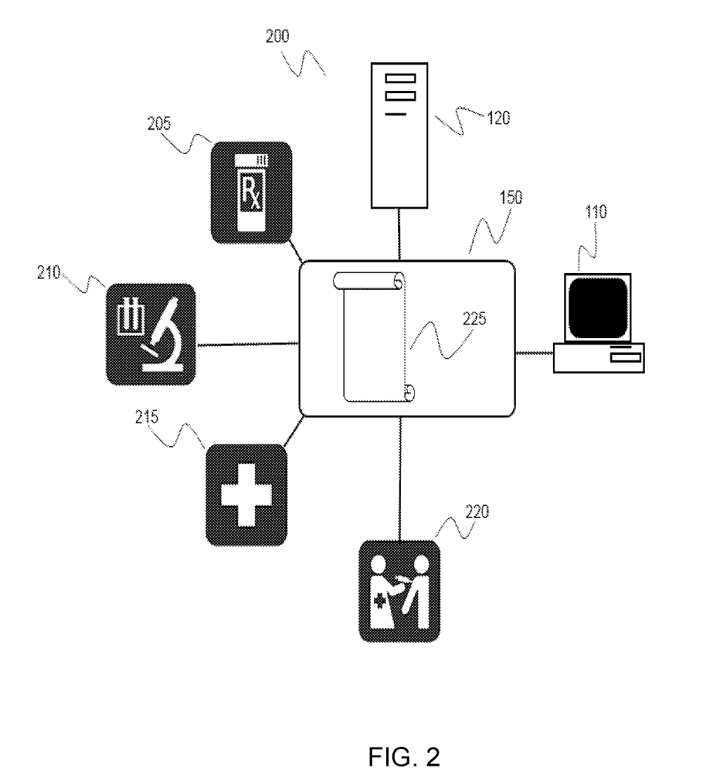

FIG. 2 shows the networking system environment previously depicted, now as the underlying framework for a non-limiting example of a medical and health services information network environment 200. Medical and health services information network 200 may include a client system 110, networking system 120 and network 150. As an example, and not by way of limitation, environment 200 may also include a pharmacy intranet 205, a clinical lab intranet 210, a hospital intranet 215, and a treating physician's practice intranet 215. Lastly, network 150 is shown as a means of transmitting a medical profile or electronic health record 225 (hereinafter EHR), which can be stored on server system 120, between every different element of the medical and health services information network environment 200.

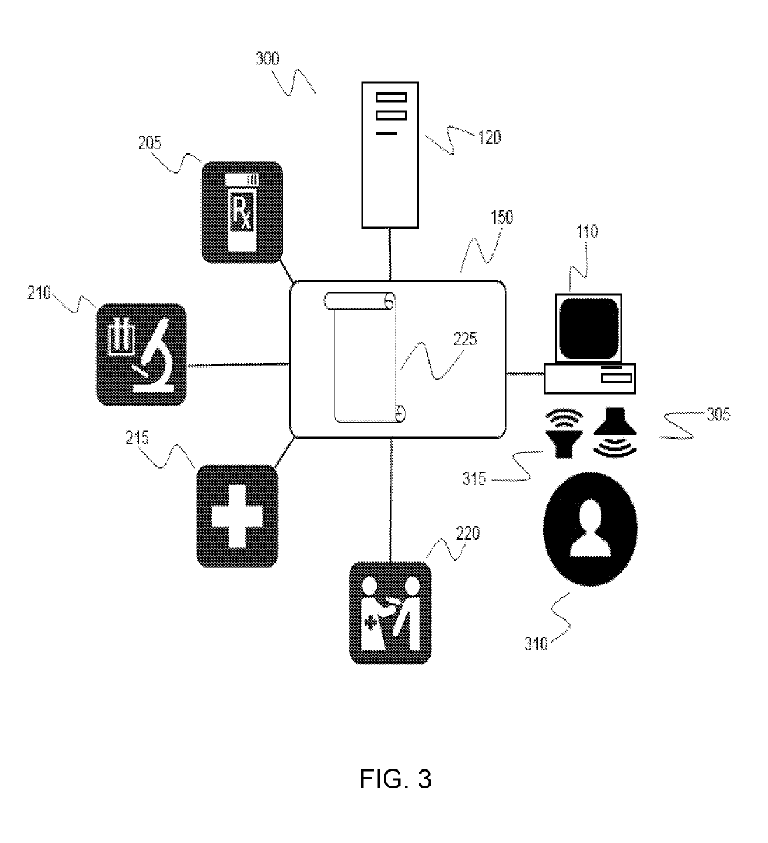

FIG. 3 represents a first step of client-side implementation 300 of the non-limiting example medical and health services information network environment, wherein client system 110 provides an auditory questionnaire via the playback of a series of discrete and synthesized or pre-recorded signals 305 to a user 310. In turn, the user 310 speaks answers 315 back to client system 110. System 110 may receive responses from the user in any suitable manner, such as, by way of example, voice input, keyboard input, written input, etc.

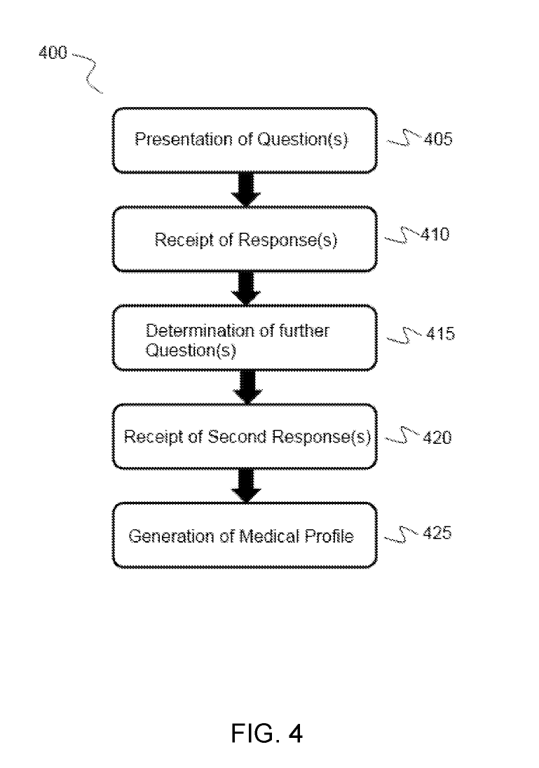

FIG. 4 illustrates a flowchart of the method as disclosed in claim 1, wherein a method 400 is disclosed. Method 400 can be performed by processing logic that can comprise hardware (e.g., circuitry, dedicated logic, programmable logic, microcode, etc.), software (e.g., instructions run on a processing device), or any combination thereof. Method 400 is first presents of one or more initial questions 405. Subsequently, method 400 receives of one or more first responses 410 to the first question(s) 405. Thereafter, method 400 is further shown determining, based on the first response(s), one or more additional questions 415 relating to the health of the implied user 310 (not shown in FIG. 4). Method 400 is then depicted in its receiving one or more second responses 420 to the additional questions. Finally, method 400 is shown in its generation 425 of a medical profile/EHR for the user.

In particular embodiments, the method 400 takes the form of a computer-implemented method comprising, by at least one processor, the presenting, for a user of an electronic device, one or more questions relating to the health of the user 310. As an example, the questions could be presented by an app on a smartphone, as a synthesized voice produced through an audio interface.

In particular embodiments, the method 400 takes the form of a computer-implemented method comprising the receiving of one or more first responses and additional questions to the first and aforementioned question. As an example, the one or more first responses are received through a microphone interface of a smartphone.

In particular embodiments, the method 400 takes the form of a computer-implemented method comprising, by at least one processor, determining, based on the first responses, one or more additional questions relating to the health of the user. As an example, a positive answer provided by a user that is a strong indicator of a certain disease process will influence the method 400 to probe further with regard to that disease process, i.e., to present question(s) as to whether other strong indicators for that same disease process might obtain for the user.

In particular embodiments, the method 400 takes the form of a computer-implemented method comprising, by at least one processor, receiving one or more second responses to the additional questions. As an example, the one or more second responses are received through a microphone interface of a personal computer.

In particular embodiments, the method 400 takes the form of a computer-implemented method comprising, by at least one processor, generating, based on the first and second responses, a medical profile for the user 310. The medical profile may include the information provided by a single or a combination of users, such as a patient user, a medical provider, a pharmacy provider, etc. In particular embodiments, the method 400 can, by the end of the interview process, generate a comprehensive list of the medical conditions and characteristics that the user 310 has or could potentially have, to include both inheritable and acquired diseases, syndromes, and so-forth. The method 400 can also conceivably be used to ascertain whether or not the user 310 is a recessive carrier for certain inherited or inheritable medical conditions or physiological traits, barring their direct phenotypic expression in the physiology of the user 310.

In particular embodiments, the method 400 further comprises the storing of identifying information for the user 310 based on at least one of the first or second responses. As an example, a voiceprint can be used to ascertain whether a given user is making use of the method 400, for a given platform or software interface.

In particular embodiments, the method 400 further comprises the identification of the user 310 based on at least one of the first or second responses matching stored identifying information. As an example, the method 400 could conceivably ask the user for his or her passport name, login ID, password, or could perform the task of identifying the user 310 on the basis of a voiceprint.

In particular embodiments, the method 400 further comprises the receiving of an authorization for the transmission of at least part of the medical profile to a medical service provider, and the initiating of the transmission of part of the medical profile to the medical service provider. As an example, the user 310 can indicate to the implementation of the method 400, through a platform or a software interface, that his or her information is authorized for its transmission to a medical service provider who can provide treatment related to what the method 400 can ascertain about the user 310 by the answers provided by the user 310.

In particular embodiments, the user 310 of client system 110 may interact with networking system 120 through any suitable graphical user interface, such as, by way of example, an application, web browser, web application, mobile application, etc. Multiple users of networking system 120 may use client systems 110 to establish profiles with networking system 120.

In particular embodiments, the questions 315 may attempt to gather medical history information about the user. In particular embodiments, client system 110 may further ask background information about the user to identify the user and determine what particular set of questions are relevant to the user. As an example, client 110 may ask: “What is your name?” “What is your age?” “What do you do for a living?” etc. In particular embodiments, system 110 stores identifying information of the user (e.g., a name, login, username, etc.) and associates it with the answers. If a user stops the questionnaire and continues at a later time, system 110 may recognize the user through questions and continues where the user previously left off In particular embodiments, client system 110 analyzes a user's voice pattern (e.g., a voiceprint) and identifies the user based on the sounds of their voice. In particular embodiments, system 110 may confirm the identity of the user (e.g., “it sounds like you are John Smith, is that correct?”).

In particular embodiments, based on answers to these background questions, system 110 may determine further questions to answer. As an example, if the user is a male over 50 years of age, system 110 may ask “When was the last time you had a lung cancer screening?” However, if the user is less than 50, the system may ask different questions (e.g., “When was your last dental checkup?”). System 110 may ask questions based on any factors, characteristics, activities, etc., such as, by way of example, age, sex, gender, habits, work, family history, etc.

In particular embodiments, system 110 continues asking questions based on previous answers. As an example, if a user previously answered that they have a family history of heart disease, the system may ask “When is the last time you checked your blood pressure?” In particular embodiments, system 110 may also direct a user to perform diagnostics if possible. As an example, system 110 may ask the user “If you have a blood pressure machine, can you please measure your blood pressure now?” In another example, a user may indicate that he/she has diabetes. As a follow-up question, system 110 may ask “What type of Diabetes, type I or type II?” Based on the user's answer, system 110 may ask additional questions relevant to the user's condition, such as, “What type of diet do you follow?” “What sugar-containing foods have you had to eat today?” In this manner, system 110 may comprehensively obtain a medical profile adapted to the user's particular context and medical history.

In particular embodiments, the medical and health services information network 200 takes the form of secure cloud storage, so as to protect any potentially sensitive information gathered. As an example, any potential medical or health information that falls under the auspices of the U.S. Health Insurance Portability and Accountability Act (HIPAA) may be stored in such a fashion as to both promote accessibility to relevant services, service-providers, and other parties for whom access to such information is desired, while simultaneously being secured against the threat of unlawful capture.

In particular embodiments, the data collected by system 110 is turned into insight, on the basis of the specific path of questions provided through the method 400 by system 110 to user 310, which insight is either explicitly encoded into or derivable from the medical profile/EHR 225. As an example, it may be determined by system 110, through any conceivable instantiation of the method 400, that the user 310 possesses a certain medical condition. System 110 can achieve this on the basis of the user 310 answering questions 305 that permit system 110 to ascertain that the user 310 possesses a decisive combination of indicators pertaining to a given medical condition.

In particular embodiments, system 110 also provides and manages key contacts from the medical community, to and for whom the user 310 volunteers answers 315. As an example, if it is determined that a given user is in possession of a certain medical condition, say allergies, the relevant specialized health care professional (general or respiratory allergist) or clinic can be notified, so as to expedite the requisite patient care.

In particular embodiments, the system 110 functions as a virtual administrator-liaison between patients and healthcare providers. As an example, the questions 305 can be formed to gather information such as insurance identification numbers, prior authorizations, previously written prescriptions, current medications under administration and their contraindications, and any of a number of administratively vital facts and permissions, thereby enabling healthcare providers and facilities to provide faster and more readily informed patient care.

In particular embodiments, the system 110 is also enabled, through the method 400 or otherwise, to track billing, payments, as well as out-of-pocket and insurance expenses, in order to measure total cost and value, either for the purposes of the user 310 or any other duly authorized individual. As an example, the system 110 can display for a user 310, within an electronic interface, what that user's monthly co-pays are for doctor's visits, prescriptions filled, etc.

In particular embodiments, the user 310 can volunteer to subscribe to a service integrated into system 110, wherein the user 310 is provided with relevant information related to any health condition he or she might possess, particularly where that information is related to new therapies, medicines, and clinical trials. As an example, if the system 110 had previously determined that the user 310 had a certain type of cancer, the system 110 could thereby provide user 310 with information about new treatments for that specific type of cancer.

In particular embodiments, the system 110 can set up medication schedules, reminders to take medication, and reminders for attending appointments with healthcare providers for a user 310. As an example, if the user 310 is required to take a prescribed medication three times daily, the system 110 can provide notifications to the user 310, by means of a proprietary application, a text message, an email or a phone call.

In particular embodiments, the system 110 can grant medical care providers access to medical history information of the user. As an example, the user may authorize access to his/her medical history through an interface of system 110. For example, the user may grant a doctor or pharmacy access to the medical history. In particular embodiments, the medical care providers may add or modify information to the medical history. For example, medical care providers may add conditions, treatments, or diagnoses to the user's medical history. Additionally, system 110 may provide recommendations or other information tailored to medical providers based on the information. As an example, system 110 may provide medical care providers with information relating to prescribed medicines, contraindications, etc.

In particular embodiments, the system 110 can track the user 310's exercise, both as it is performed and projecting into the future, so as to enable the user 310 to meet his or her fitness goals. As an example, previously scheduled workout routines can be programmed into system 110, while workout routines that have been performed by the user 310 can be logged as such into system 110 through an integrated device, from a PC to a tablet to a phone.

In particular embodiments, the system 110 can be used to manage nutrition, allergies, vitamins and medication for the user 310. As an example, timely data that effects or reflects a user 310's relevant medical needs can be input into system 110 by the user 310, so that system 110 can offer considerations as to how the user 310 might manage parameters such as vitamin intake, the voluntary administration of allergy mediation, and so-forth.

In particular embodiments, the system 110 can be configured to permit the fluid switching back-and-forth between multiple different users 310, where one or more user can be authorized to view the information of others. As an example, within the context of a family, a mother and/or a father can be provided with privileged access to medical information that pertains to his, her or their children.

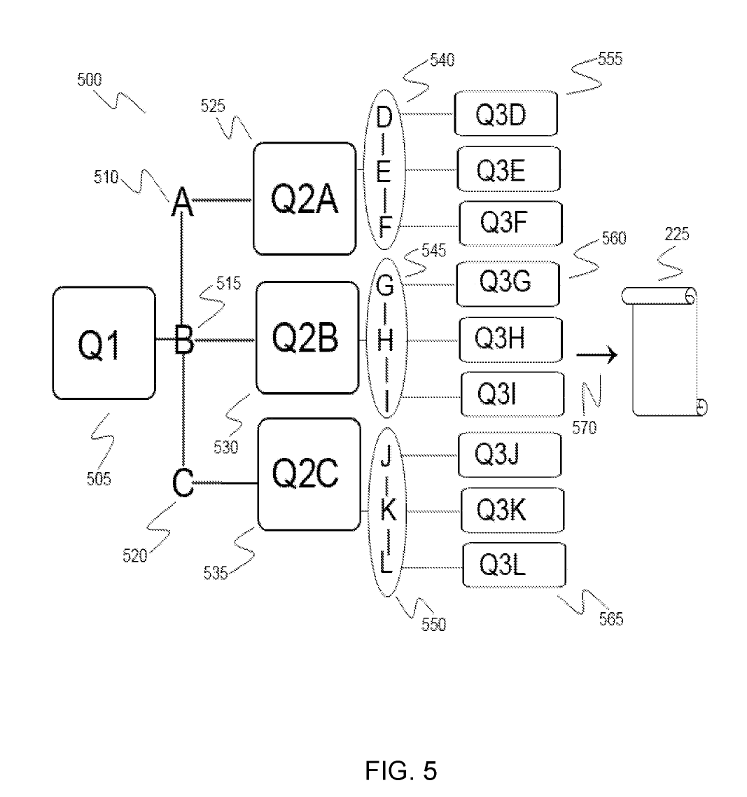

FIG. 5 illustrates an example non-limiting decision-tree 500 as a further determination of the previously disclosed method 400. In this example embodiment, a first question 505 is represented as a rectangular box labeled Q1. Subsequent to this, possible first responses 510, 515 and 520 to first question 505 are represented by the capital letters A, B, and C, respectively. Further into the decision tree 500, potential questions 525, 530 and 535 are represented by the boxes labeled Q2A, Q2B and Q2C, respectively. Still further into the decision tree 500 lie three separate series each of three (3) distinctive potential responses 540, 545 and 550, represented by three ellipses containing the letters D-E-F, G-H-I, and J-K-L, respectively. In the next represented portion of the depiction of the decision tree 500, three distinctive series of three (3) new possible questions each are represented as question-sets 555, 560 and 565. Question set 555 contains the questions labeled Q3D, Q3E and Q3F, while question sets 560 and 565 contain the questions labeled Q3G, Q3H, Q3I, and Q3J, Q3K and Q3L, respectively. Penultimately, an arrow 570 pointing towards the right of the page is provided to depict the notion of the potential continuation of the decision tree 500, leading up to the medical profile/EHR 225 as a product of the execution of the decision tree 500.

FIG. illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example, computer system 600 may be an embedded computer system, a desktop computer system, a laptop or notebook computer system, a mainframe, a mobile telephone, a personal digital assistant (PDA), a server, a tablet computer system, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, memory 604 includes random access memory (RAM). This RAM may be volatile memory, where appropriate Memory 604 may include one or more memories 604, where appropriate. Although this disclosure describes and illustrates particular memory, this disclosure contemplates any suitable memory.

In particular embodiments, storage 606 includes mass storage for data or instructions. As an example, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

It is to be appreciated that the Detailed Description section, and not the Summary and Abstract sections (if any), is intended to be used to interpret the claims. The Summary and Abstract sections (if any) may set forth one or more but not all exemplary embodiments of the invention as contemplated by the inventor(s), and thus, are not intended to limit the invention or the appended claims in any way.

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the invention should not be limited by any of the above-described exemplary embodiments, but should be defined only in accordance with the following claims and their equivalents.

What is claimed is:

1. A computer-implemented method comprising, by at least one processor:
presenting, for a user of an electronic device, one or more questions relating to the health of the user;
receiving one or more first responses to the first questions;
determining, based on the first responses, one or more additional questions relating to the health of the user;
receiving one or more second responses to the additional questions; and
generating, based on the first and second responses, a medical profile for the user.

2. The method of claim 1, wherein the one or more questions and additional questions are presented as a synthesized voice through an audio interface of the electronic device.

3. The method of claim 1, wherein the one or more first and second responses are received through a microphone interface of the electronic device.

4. The method of claim 1, the method further comprising:
storing identifying information for the user based on at least one of the first or second responses.

5. The method of claim 4, further comprising:
identifying the user based on at least one of the first or second responses matching stored identifying information.

6. The method of claim 5, wherein the identifying information comprises at least one of a name, a login, a password, or a voiceprint.

7. The method of claim 1, further comprising:
receiving an authorization for the transmission of at least part of the medical profile to a medical service provider; and
initiating the transmission of the part of the medical profile to the medical service provider; and
receiving, from the medical service provider, a response associated with the part of the medical profile.

8. The method of claim 1, where the electronic device comprises at least one of a smartphone, a personal computer, a mobile device, or a voice-interaction device.

9. A system, comprising:
a memory; and
at least one processor coupled to the memory and configured to:
present, for a user of an electronic device, one or more questions relating to the health of the user;
receive one or more first responses to the first questions;
determine, based on the first responses, one or more additional questions relating to the health of the user;
receive one or more second responses to the additional questions; and
generate, based on the first and second responses, a medical profile for the user.

10. The system of claim 9, wherein the one or more questions and additional questions are presented as a synthesized voice through an audio interface of the electronic device.

11. The system of claim 9, wherein the one or more first and second responses are received through a microphone interface of the electronic device.

12. The system of claim 9, the system further comprising:
a memory; and
at least one processor coupled to the memory and configured to:
identify the user based on at least one of the first or second responses matching stored identifying information.

13. The system of claim 12, the system further comprising:
a memory; and
at least one processor coupled to the memory and configured to:
store identifying information for the user based on at least one of the first or second responses.

14. The system of claim 13, wherein the identifying information comprises at least one of a name, a login, a password, or a voiceprint.

15. A tangible computer-readable device having instructions stored thereon that, when executed by at least one computing device, causes the at least one computing device to perform operations comprising:
presenting, for a user of an electronic device, one or more questions relating to the health of the user;
receiving one or more first responses to the first questions;
determining, based on the first responses, one or more additional questions relating to the health of the user;
receiving one or more second responses to the additional questions; and
generating, based on the first and second responses, a medical profile for the user.

16. The tangible computer-readable device of claim 15, wherein the one or more questions and additional questions are presented as a synthesized voice through an audio interface of the electronic device.

17. The tangible computer-readable device of claim 15, wherein the one or more first and second responses are received through a microphone interface of the electronic device.

18. The tangible computer-readable device of claim 15, further comprising:
identifying the user based on at least one of the first or second responses matching stored identifying information.

19. The tangible computer-readable device of claim 18, further comprising:
storing identifying information for the user based on at least one of the first or second responses.

20. The tangible computer-readable device of claim 19, wherein the identifying information comprises at least one of a name, a login, a password, or a voiceprint.
